(19) United States
(12) Patent Application Publication
(10) Pub. No.: US 2011/0134038 A1
(43) Pub. Date: Jun. 9, 2011

(54) INPUT DEVICE

(76) Inventors: Chih-Ming TSAO, Zhonghe City (TW); Ya-Ting Cheng, Zhonghe City (TW)

(21) Appl. No.: 12/960,077

(22) Filed: Dec. 3, 2010

(30) Foreign Application Priority Data
Dec. 4, 2009 (TW) 098141550

(51) Int. Cl. G06F 3/033

(52) U.S. Cl. 345/163

(57) ABSTRACT

An input device includes a housing having an outer surface for touching by an external object, object sensors mounted in the housing for sensing the location of an external object touching the outer surface of the housing and generating a corresponding location signal, a displacement sensor module for sensing the amount and direction of movement of the housing and generating a corresponding displacement coordinate signal, and a control module for calculating track signals subject to received location signals and displacement coordinate signals for transmission to an external computer for cursor control.

This application claims the priority benefit of Taiwan patent application number 098141550, filed on Dec. 4, 2009.

### BACKGROUND OF THE INVENTION

1. Field of the Invention

The present invention relates to computer input device operation control technology and more particularly, to an input device, which comprises object sensors adapted to scan the surface of the housing of the input device and to generate location signals of external objects at the surface of the housing, and a control module for transforming the location signals received from the object sensors into a new coordinate system and calculating a track signal indicative of direction and amount of movement of the housing of the input device sensed by a displacement sensor module subject to the new coordinate system for transmission to an external computer for cursor control.

2. Description of the Related Art

In computer systems, keyboard and mouse are the most popularly used input devices. Further, a mouse can be used to substitute for the directional keys of a keyboard for displacement track input. In a computer operating system, mouse has become a requisite peripheral apparatus. Many application software and instructions can be conveniently operated and executed through a mouse. The use of a mouse greatly facilitates the operation of a computer system.

Normally, a mouse has a directional characteristic, i.e., when using a mouse, the user must hold the mouse in a particular direction for operation. The internal control module of a mouse can simply determine the displacement track in this particular direction. This limitation causes inconvenience in use. A conventional mouse A, as shown in FIG.7, has a front side A1, a rear side A2 and opposing left side A3 and right side A4. When using the mouse A, the user must keep the front side A1 and the rear side A2 in Y-axis direction and the opposing left side A3 and right side A4 in X-axis direction so that the mouse A can be operated accurately. Further, the mouse A comprises a left button A11, a right button A12 and a scroll button A13 on the front side A1. Therefore, this mouse A must be operated by the right hand and kept in one single direction. Operating this design of mouse is not convenient to all different users.

To fit right-handed and left-handed users, prior art discloses a mouse device comprising a mouse left button and a mouse right button for producing a respective clicking signal upon triggering by a user, and a mode-switching key for switching between a left-handed operation mode and a right-handed operation mode. When a user clicks the mouse left button or mouse right button, the mouse left button or mouse right button will produce a respective clicked signal subject to the left-handed operation mode or right-handed operation mode, and the clicked signal will be transmitted to the computer for cursor control.

However, the aforesaid left-handed and right-handed dual-mode mouse device still must be kept in a particular direction for accurate operation. This directional limitation limits the configuration design of the mouse device and its use.

Therefore, it is desirable to provide an input device that eliminates the aforesaid problems.

### SUMMARY OF THE INVENTION

The present invention has been accomplished under the circumstances in view. It is one external object of the present invention to provide an input device, which eliminates the drawbacks of the conventional mouse devices.

To achieve this and other objects, an input device comprises a housing, object sensors, a control module and a displacement sensor module. The object sensors are mounted in the housing and adapted to sense the presence of external objects on the surface of the housing. When sensed the presence of external objects on the surface of the housing, the object sensors transmit location signals to the control module. Upon receipt of the location signals from the object sensors, the control module reads the new coordinate system. When received displacement coordinate signals from the displacement sensor module, the control module calculates the track signal subject to the received location signals and displacement coordinate signals, and transmits the track signal to the computer for cursor control. Thus, when the direction of the input device is changed, a new coordinate system will be created, enabling the track signal produced subject displacement of the housing to be transmitted to the computer for cursor control.

Further, the object sensors of the input device can detect the location of every object at the surface of the housing to generate a respective location signal so that the control module can determine the type of the object, for example, the thumb or the little finger, subject to the coordinate location of the location signal, and therefore it can be known that the user is using his (her) left hand or right hand in operating the input device.

### BRIEF DESCRIPTION OF THE DRAWINGS

FIG. 1 is a perspective view of an input device in accordance with the present invention.

FIG. 2 is an exploded view of the input device shown in FIG. 1.

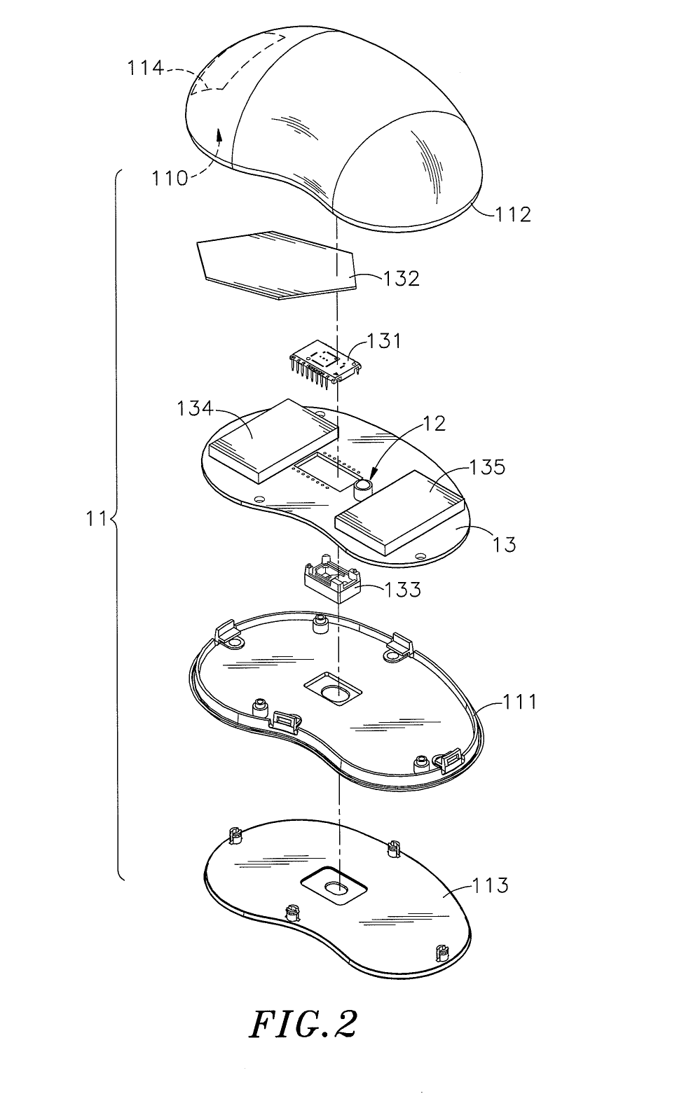

FIG. 3 is a circuit block diagram of the input device shown in FIG. 1.

FIG. 4 is an operation flow chart of the present invention.

FIG. 5 is a schematic drawing illustrating an operation status of the input device in accordance with the present invention.

FIG. 6 is a perspective view of an alternate form of the input device in accordance with the present invention.

FIG. 7 is a top plain view of a mouse according to the prior art.

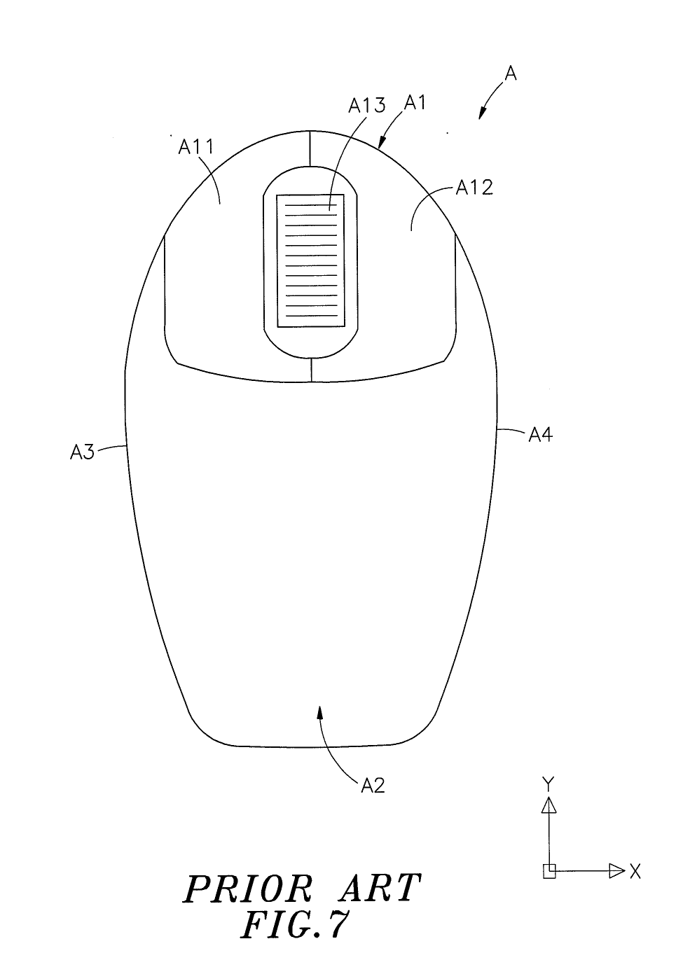

### DETAILED DESCRIPTION OF THE PREFERRED EMBODIMENT

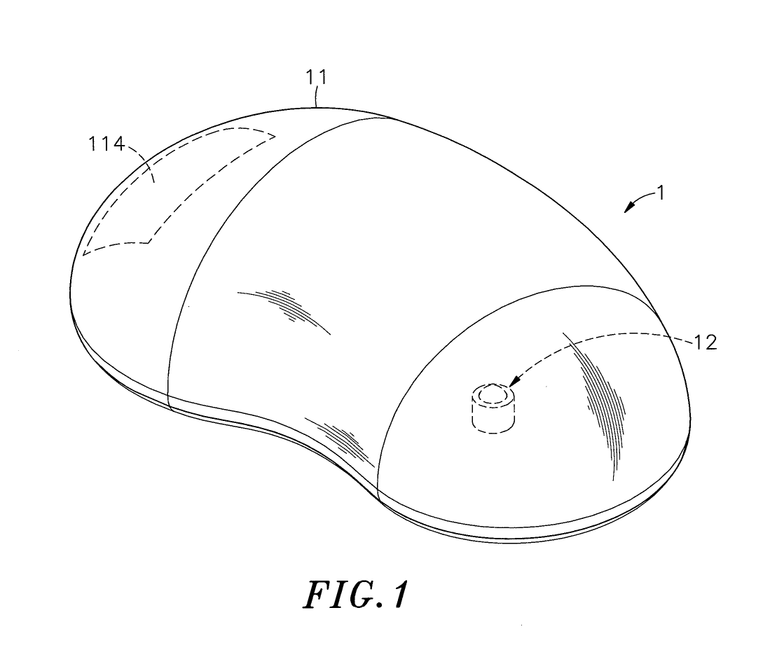

Referring to FIGS. 1˜3, an input device 1 in accordance with the present invention is shown comprising a housing 11, at least one object sensor 12 and a circuit substrate 13.

The housing 11 comprises a bottom cover shell 111, a top cover shell 112 covering the bottom cover shell 111, an accommodation chamber 110 defined in between the top cover shell 112 and the bottom cover shell 111, and a cushion pad 113 affixed to the bottom side of the bottom cover shell 111. The top cover shell 112 of the housing 11 has at least one sensing zone 114 defined in the surface thereof.

The at least one object sensor 12 is disposed at one side relative to the surface of the housing 11 for sensing the presence of an external object, for example, the user's fingers or pen on the surface of the housing 11. The at least one object sensor 12 can be, for example, a mechanical key switch protruding over the surface of the housing 11, a capacitive or resistive touch panel disposed at the inner side of the surface of the housing 11, or a CCD (charge coupled device), CMOS (complementary metal-oxide semiconductor), DB/IR (direct-beam infrared ray) or DF/IR (diffuse infrared ray) sensor mounted in the accommodation chamber 110 corresponding to the at least one sensing zone 114 of the housing 11.

The circuit substrate 13 is mounted in the accommodation chamber 110 inside the housing 11 carrying multiple electronic components and a circuit layout (not shown). The electronic components include a control module 131, a touch panel 132, a displacement sensor module 133, a transmission module 134 and a power supply module 135. The control module 131 is electrically connected with the touch panel 132, the displacement sensor module 133, the transmission module 134 and the power supply module 135. Each object sensor 12 is also electrically connected with the control module 131. Further, the displacement sensor module 133 can use a CCD (charge coupled device) image sensor, CMOS (complementary metal-oxide semiconductor) image sensor or infrared sensor to match with a LED or laser LED for measuring displacement of the housing 11 of the input device 1 in X-axis and Y-axis. The light reflected by a target passes through the receiver lens and is focused on the sensor. The light quantity distribution of the entire beam spot entering the light receiving element is used to determine the beam spot center and identifies this as the target position. Subject to the functioning of the displacement sensor module 133, the direction and amount of movement of the housing 11 are detected. The power supply module 135 can be a storage battery or dry battery adapted to provide the circuit substrate 13 with the necessary working power.

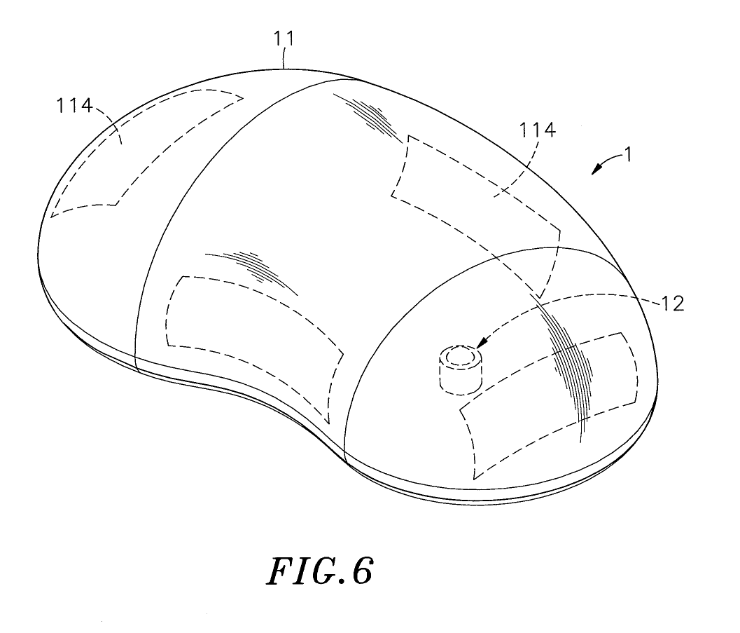

Further, in the embodiment shown in FIG. 1, the top cover shell 112 of the housing 11 has one sensing zone 114 defined in the front side of the surface thereof. In an alternate form of the present invention as shown in FIG. 6, the top cover shell 112 of the housing 11 has multiple sensing zones 114 defined in the surface thereof at the front and rear sides and the two opposite lateral sides.

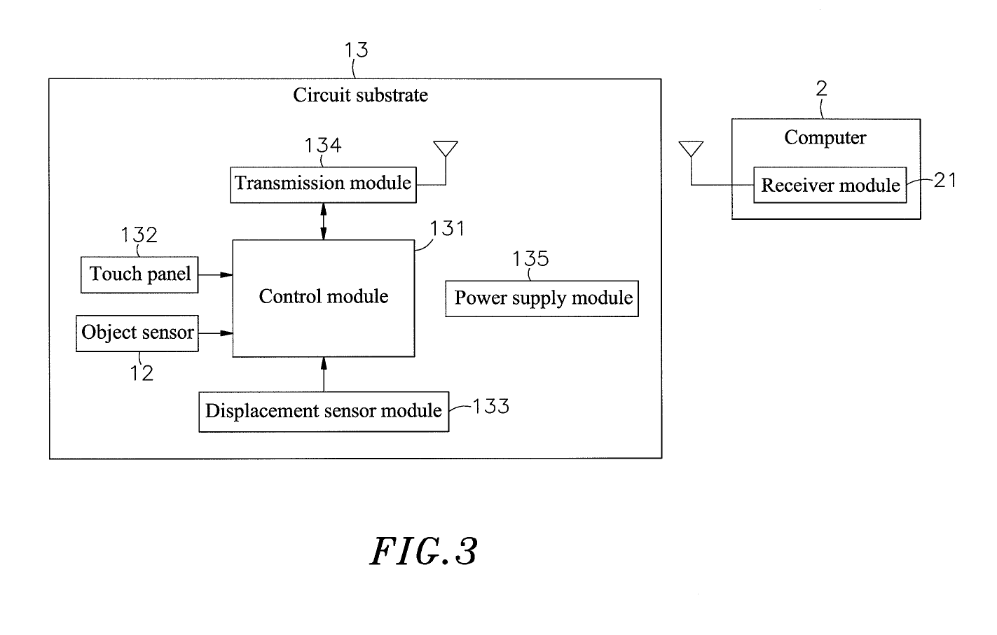

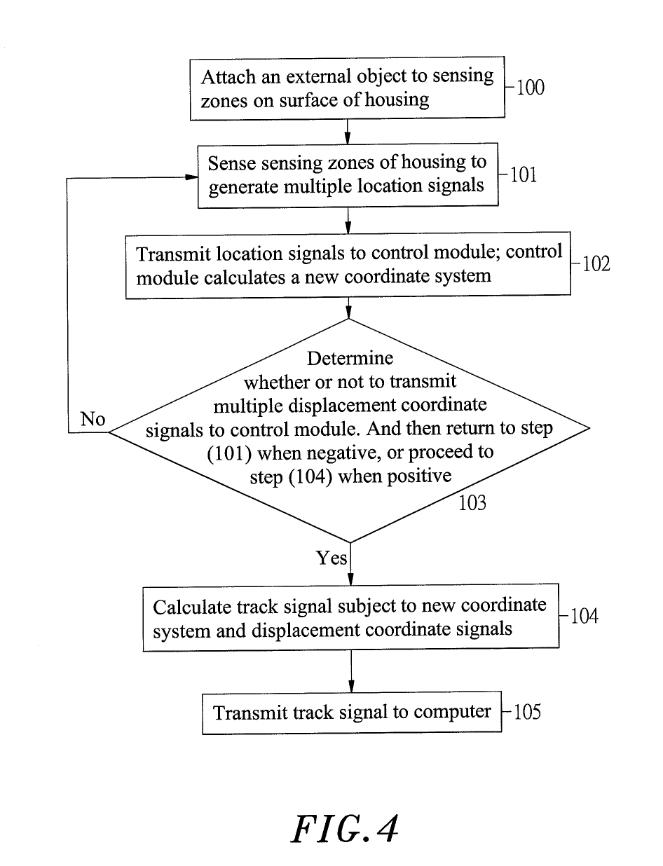

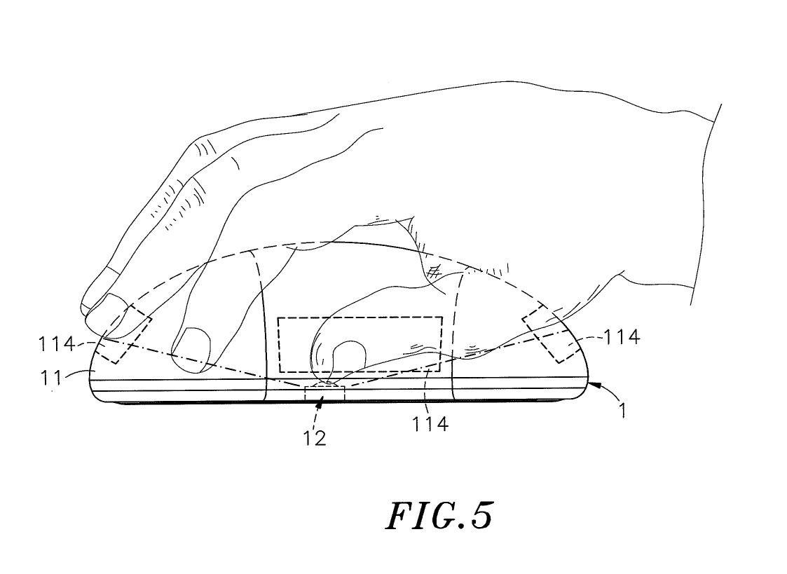

Referring to FIGS. 4 and 5 and FIGS. 3 and 6 again, when an external objects, for example, the fingers of a user touch the sensing zones 114 of the housing 11, the directional position of the input device 1 is determined subject to the locations of the user's fingers rested on the surface of the housing 11. This determination procedure runs subject to the following steps:
(100) Attach an external object to the sensing zones 114 on the surface of the housing 11.
(101) Sense the sensing zones 114 of the housing 11 to generate multiple location signals.
(102) Transmit the location signals to the control module 131, enabling the control module 131 to calculate a new coordinate system.
(103) Determine whether or not to transmit multiple displacement coordinate signals to the control module 131, and then return to step (101) when negative, or proceed to step (104) when positive.
(104) Calculate a track signal subject to the new coordinate system and the displacement coordinate signals.
(105) Transmit the track signal to the computer 2.

Further, the aforesaid computer 2 can be a desk computer, notebook computer or PDA (personal digital assistant). The multiple object sensors 12, for example, DF/IR (diffuse infrared ray) sensors are mounted in the accommodation chamber 110 corresponding to the respective sensing zones 114 of the housing 11, each having illumination means for illuminating the respective sensing zone 114 with infrared light that arrives at the respective sensing zone 114 from a plurality of different illumination directions, and video imaging means for receiving the diffuse infrared light reflected from the respective sensing zone 114 and for generating a video image of the respective sensing zone 114 based on the diffuse infrared light reflected from the respective sensing zone 114. Subject to the operation of the object sensors (DF/IR sensors) 12, respective location signals are produced and transmitted by the object sensors (DF/IR sensors) 12 to the control module 131. Alternatively, CCD or CMOS image sensors may be used to match with a LED or laser LED for measuring displacement of the housing 11 of the input device 1 in X-axis and Y-axis. In this case, the housing 11 is made of a transparent or semitransparent material so that the object sensors 12 determine the coordinate location of the external object subject to the shadow of the external object at the surface of the housing 11. It is to be understood that the types of the object sensors 12 and their installation may be variously embodied for sensing the location of the external object at the surface of the housing 11.

When a user is going to operate the input device 1, which can be made in the form of, for example, a mouse, the user will attach the fingers to the surface of the housing 11 of the input device 1 corresponding to the sensing zones 114. The object sensors 12 keep scanning the sensing zones 114 after startup of the input device 1. When the user attaches the fingers to the at least one sensing zone 114, the at least one object sensor 12 keep sensing the coordinate locations of the user's fingers at the sensing zones 114 to produce respective location signals and to send the sensed location signals to the control module 131. Thereafter, the control module 131 read the location signals to calculate a new coordinate system. Therefore, the control module 131 determines whether or not multiple displacement coordinate signals have been received from the displacement sensor module 133. Upon receipt of the location signals and the displacement coordinate signals, the control module 131 translates the displacement coordinate signals into corresponding displacement coordinate data, i.e., track signals, subject to the new coordinate system.

The transformation of the coordinate system is executed subject to a predetermined coordinate system and formula stored in the control module 131. The predetermined formula is employed subject to the predetermined coordinate system {O:i,j}, i.e., the coordinate system produced subject to the last sensing operation of the at least one object sensor 12 in sensing the at least one sensing zone 114 is used to execute coordinate system transformation, in which O is the coordinate of the reference point, normally indicated by (0,0); i is the coordinate system of x-axis; j is the coordinate system of y-axis, i.e., all x-axis coordinates produced during movement or sensing of the input device 1 belong to i, and all y-axis coordinates produced during movement or sensing of the input device 1 belong to j. If the at least one object sensor 12 senses the presence of the external object at a different location at the surface of the housing 11, a new coordinate system {O′:i′,j′} will be produced.

In more detail, the transformation of a new coordinate system is to define an old coordinate system data {O:i,j} and a new coordinate system data {O′:i′,j′} and then to finish the transformation by means of two steps, i.e., to translate the old coordinate data {O:i,j} into a new coordinate system data {O′:i′,j′} at first, and then to rotate this new coordinate system data O′ through an angle θ=∠(i, i′), thereby obtaining a new coordinate system data {O′:i′,j′}.

P: the reference point of the old coordinate system.

i: the transverse axis of the old coordinate system.

J: the longitudinal axis of the old coordinate system.

O′: the reference point of the new coordinate system.

i′: the transverse axis of the new coordinate system.

j′: the longitudinal axis of the new coordinate system.

θ: the angle of rotation between the new and old coordinate systems.

(X, Y): the coordinates of the old coordinate system.

(X′, Y′): the coordinates of the new coordinate system.

a: the displacement amount of X′ relative to the transverse axis of the old coordinate system.

b: the displacement amount of Y′ relative to the transverse axis of the old coordinate system.

According to the aforesaid predetermined formula, when the coordinates of the old coordinate data {O:i,j} and the new coordinate system data {O′:i′,j′} are (X, Y) and (X′, Y′) respectively, X, Y are respectively translated into X′, Y′, in which X′, Y′ can be:

{x′=(x−a)cos θ+(y−b)sin θ=x cos θ+y sin θ−a cos θ−b sin θ

{y′=(x−a)sin θ+(y−b)cos θ=−x sin θ+y cos θ+a sin θ−cos θ

The aforesaid formula is simply an example for explanation purpose only but not to be used as a limitation.

Thus, the control module 131 can translate the received multiple displacement coordinate signals into respective new displacement coordinate signals, or the said track signals, subject to the new coordinate system, and then send these track signals to the receiver module 21 of the computer 2 through the transmission module 134 for cursor control, achieving multi-direction control of the input device 1.

On the other hand, when a user attach the fingers to the surface of the housing 11 of the input device 1 over the sensing zones 114, the thumb and the little finger will be respectively rested on the two sensing zones 114 at the two opposite lateral sides of the housing 11, and the index finger and the middle finger are rested will be rested on the sensing zone 114 at the front side of the housing 11. At this time, the object sensors 12 will sense the coordinate locations of the user's fingers at the respective sensing zones 114. At this time, the area of the thumb at one of the sensing zones 114 will be larger than the area of the little finger at another of the sensing zones 114, and a relatively greater number of coordinate locations will be generated for a relative larger sensed area to form multiple location signals. After receipt of multiple location signals from the object sensors 12 by the control module 131, the control module 131 determine the user's thumb or little finger to be located on the surface of the housing 11 at the left side or right side (the area of the thumb is relatively larger) subject to the location signals received from the object sensors 12, knowing that the user is using the left hand or right hand to operate the input device 1. Thus, the invention enhances the flexibility of the use of the input device 1.

This input device 1 has multi-direction and left and right hand control functions, and therefore the operation of the input device 1 is free from limitations in direction or left/right hand operation, i.e., a left-handed user as well as a right-handed user can operate the input device 1 in any direction to control the operation of the computer 2. When a left-handed or right-handed user operates the input device 1 in any direction, the control module 131 of the circuit substrate 13 can make judgment and calculation to define the coordinate locations and to establish a new coordinate system. After transmission of displacement coordinate signals by the displacement sensor module 133 to the control module 131, the control module 131 will calculate a new track signal subject to the new location signals and the received displacement coordinate signals. This track signal is indicative of the displacement of the input device 1 sensed by the displacement sensor module 133.

The above description is simply for understanding of the features of the present invention but not intended for use as limitations of the scope of the invention. Further, the object sensors can be direct-beam type sensors, for example, DB/IR (direct-beam infrared) sensors evenly arranged inside the housing 11 to determine the location of an external object at the surface of the housing 11 subject to shading status of the surface of the housing 11. Alternatively, mechanical key switches may be evenly arranged on the surface of the housing 11 so that when an external object touches one particular area of the surface of the housing 11, the respective key switch will be switched to produce a signal indicative of the location of the external object at the surface of the housing 11. Either of the aforesaid methods can cause the object sensors 12 to produce location signals subject to the locations of the external objects rested on the surface of the housing 11, and the control module 131 will update the storage coordinate system subject to the location signals provided by the object sensors 12. Thus, the input device 1 can be operated in any direction to control the computer 2.

Further, the sensing zones 114 can cover the whole area or a part of the surface of the housing 11. In the drawings, the arrangements of the sensing zones 114 are examples for illustration only, but not intended for use as limitations.

In conclusion, the input device of the present invention has advantages and features as follows:
1. The input device 1 comprises a housing 11, object sensors 12, a control module 131 and a displacement sensor module 133. The object sensors 12 are mounted in the housing 11 and adapted to sense the presence of external objects on the surface of the housing 11. When sensed the presence of external objects on the surface of the housing 11, the object sensors 12 transmit location signals to the control module 131. Upon receipt of the location signals from the object sensors 12, the control module 131 reads the new coordinate system. When received displacement coordinate signals from the displacement sensor module 133, the control module 131 calculates the track signal subject to the received location signals and displacement coordinate signals and transmits the track signal to the computer 2 for cursor control. Thus, when the direction of the input device 1 is changed, a new coordinate system will be created, enabling the track signal produced subject displacement of the housing 11 to be transmitted to the computer 2 for cursor control.
2. The object sensors 12 of the input device 1 can detect the location of every object on the surface of the housing 11 to generate a respective location signal so that the control module 131 can determine the type of the object, for example, the thumb or the little finger, subject to the coordinate location of the location signal, and therefore it can be known that the user is using his (her) left hand or right hand in operating the input device 1.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An input device operable by a user to control a computer, comprising:
a housing, said housing comprising an outer surface for touching by an external object and an accommodation chamber defined therein;
at least one object sensor mounted in said accommodation chamber inside said housing and adapted for sensing the location of an external object touching said outer surface of said housing and generating a location signal subject to the sensing result;
a displacement sensor module mounted in said accommodation chamber inside said housing and adapted for sensing the amount and direction of movement of said housing on a flat surface and generating displacement coordinate signals corresponding to the movement of said housing; and
a control module mounted in said accommodation chamber inside said housing and electrically connected with said at least one object sensor and said displacement sensor module and adapted for receiving location signals produced by said at least one object sensor and displacement coordinate signals produced by said displacement sensor module and calculating track signals subject to the received location signals and displacement coordinate signals for transmission to an external computer for cursor control.

2. The input device as claimed in claim 1, wherein each said object sensor is a mechanical key switch protruding over the surface of said housing and operable by an external object.

3. The input device as claimed in claim 1, wherein said at least one object sensor is a capacitive or resistive touch panel disposed in said outer surface of said housing.

4. The input device as claimed in claim 1, wherein said housing further comprises a plurality of sensing zones disposed in said outer surface; said at least one object sensor is mounted in said accommodation chamber inside said housing corresponding to said sensing zones.

5. The input device as claimed in claim 4, wherein said at least one object sensor is respectively selected from the group of CCD (charge coupled device), CMOS (complementary metal-oxide semiconductor), DB/IR (direct-beam infrared ray) and DF/IR (diffuse infrared ray) sensors.

6. The input device as claimed in claim 1, further comprising a transmission module electrically connected to said control module and controllable by said control module to transmit track signals calculated by said control module to an external computer.

7. The input device as claimed in claim 6, further comprising a power supply module adapted to provide the input device with the necessary working power supply, wherein said transmission module is a wireless transmission module adapted for transmitting track signals calculated by said control module to an external computer wirelessly.

8. The input device as claimed in claim 1, further comprising a touch panel mounted in said accommodation chamber inside said housing and attached to said outer surface and electrically connected to said control module.
